(19) United States
(12) Patent Application Publication
(10) Pub. No.: US 2026/0119378 A1
(43) Pub. Date: Apr. 30, 2026

(54) TEST CODE GENERATION USING ARTIFICIAL INTELLIGENCE

(71) Applicant: Black Duck Software, Inc., Burlington, MA (US)

(72) Inventors: David Autrey BOHANNON, Sugar Hill, GA (US); John T. MCSHANE, Seneca, SC (US)

(21) Appl. No.: 18/929,903

(22) Filed: Oct. 29, 2024

(51) Int. Cl. G06F 11/36; G06F 11/07

(52) U.S. Cl. CPC G06F 11/3688; G06F 11/0766

(57) ABSTRACT

The present disclosure describes a computer system for generating test code. According to an embodiment, the computer system includes one or more memories and one or more processors communicatively coupled to the one or more memories. The one or more processors, individually or collectively, parse software code to determine a function in the software code, generate a prompt based on the function, generate, using a machine learning model and based on the prompt, test code for testing the function, and execute the test code to generate a crash.

### TECHNICAL FIELD

The present disclosure relates to generating test code using artificial intelligence.

### BACKGROUND

Software code is tested prior to releasing or deploying the software code. Part of the testing may involve executing functions within the software code to determine whether the functions throw errors or generate crashes when executed. These errors and crashes may be resolved prior to releasing or deploying the software code.

### SUMMARY

The present disclosure describes a computer system for generating test code. According to an embodiment, the computer system includes one or more memories and one or more processors communicatively coupled to the one or more memories. The one or more processors, individually or collectively, parse software code to determine a function in the software code, generate a prompt based on the function, generate, using a machine learning model and based on the prompt, test code for testing the function, and execute the test code to generate a crash.

The one or more processors may, individually or collectively, prior to executing the test code to generate the crash, execute the test code to generate an error, communicate the error to the machine learning model, and adjust, using the machine learning model, the test code to resolve the error.

The one or more processors may, individually or collectively, determine a plurality of functions in the software code based on parsing the software code, rank the plurality of functions based on characteristics of the plurality of functions, and select the function from the plurality of functions based on a rank of the function. The characteristics may include at least one of a number of arguments, whether a function is an internal function, a name of a function, or a complexity of a function.

The prompt may include at least one of a role to be played when generating the test code or an example of test code to be generated.

The one or more processors may, individually or collectively, communicate the crash to the machine learning model, and adjust, using the machine learning model, the software code to resolve the crash.

The one or more processors may, individually or collectively, analyze a stack trace for the crash to determine that the function was not invoked when executing the test code and discard the crash based on determining that the function was not invoked when executing the test code.

The one or more processors may, individually or collectively, adjust, using the machine learning model, the test code based on determining that the function changed.

According to another embodiment, a method for generating test code includes parsing software code to determine a function in the software code, generating a prompt based on the function, generating, using a machine learning model and based on the prompt, test code for testing the function, and executing the test code to generate a crash.

The method may include, prior to executing the test code to generate the crash, executing the test code to generate an error, communicating the error to the machine learning model, and adjusting, using the machine learning model, the test code to resolve the error.

The method may include determining a plurality of functions in the software code based on parsing the software code, ranking the plurality of functions based on characteristics of the plurality of functions, and selecting the function from the plurality of functions based on a rank of the function. The characteristics may include at least one of a number of arguments, whether a function is an internal function, a name of a function, or a complexity of a function.

The prompt may include at least one of a role to be played when generating the test code or an example of test code to be generated.

The method may include communicating the crash to the machine learning model and adjusting, using the machine learning model, the software code to resolve the crash.

The method may include analyzing a stack trace for the crash to determine that the function was not invoked when executing the test code and discarding the crash based on determining that the function was not invoked when executing the test code.

The method may include adjusting, using the machine learning model, the test code based on determining that the function changed.

According to another embodiment, a non-transitory computer readable medium stores instructions for generating test code that, when executed by one or more processors, cause the one or more processors to, individually or collectively, parse software code to determine a function in the software code, generate a prompt based on the function, generate, using a machine learning model and based on the prompt, test code for testing the function, execute the test code to generate an error, adjust, using the machine learning model, the test code to resolve the error, and execute the adjusted test code to generate a crash.

The instructions may further cause the one or more processors to, individually or collectively, determine a plurality of functions in the software code based on parsing the software code, rank the plurality of functions based on characteristics of the plurality of functions, and select the function from the plurality of functions based on a rank of the function. The characteristics may include at least one of a number of arguments, whether a function is an internal function, a name of a function, or a complexity of a function.

The prompt may include at least one of a role to be played when generating the test code or an example of test code to be generated.

### BRIEF DESCRIPTION OF THE DRAWINGS

Thedisclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example operation for testing software code performed by a computer system.

FIG. 2 illustrates an example operation for parsing software code performed by a computer system.

FIG. 3 illustrates an example operation for generating a prompt performed by a computer system.

FIG. 4 illustrates an example operation for generating test code performed by a computer system.

FIG. 5 illustrates an example operation for executing test code performed by a computer system.

FIG. 6 illustrates an example operation for adjusting test code performed by a computer system.

FIG. 7 is a flowchart of an example method for testing software code performed by a computer system.

FIG. 8 depicts a diagram of an example computer system in which embodiments of the present disclosure may operate.

### DETAILED DESCRIPTION

Aspects of the present disclosure relate to testing software code using artificial intelligence. One technique used to test software code is executing test code that invokes or executes functions within the software code or exposed by the software code. As software code becomes more complex, however, the software code includes or exposes more functions. Manually generating the test code to invoke or execute the functions for testing purposes may not be possible. As a result, the software code may not be fully tested and may throw errors or crash when deployed.

The present disclosure describes a computer system that uses artificial intelligence to generate test code for testing functions in software code. The computer system parses software code to determine the functions included in the software code. The computer system then generates prompts using the determined functions and directs those prompts to a machine learning model (e.g., a large language model). The machine learning model analyzes the prompt and generates test code to execute or invoke the functions. The test code may then be executed to detect bugs within the functions. For example, executing the test code may generate a crash that should be resolved prior to deploying the software code.

In particular embodiments, the computer system provides several technical advantages. For example, the computer system may generate test code that tests functions within software code, even causing crashes to occur. As a result, the computer system may reduce the number of bugs or errors in the software code prior to deploying the software code. As another example, the computer system may improve the functioning of a computer system by allowing bugs in functions to be detected and fixed, which may prevent the functions from crashing the computer system when the functions are invoked, called, or executed.

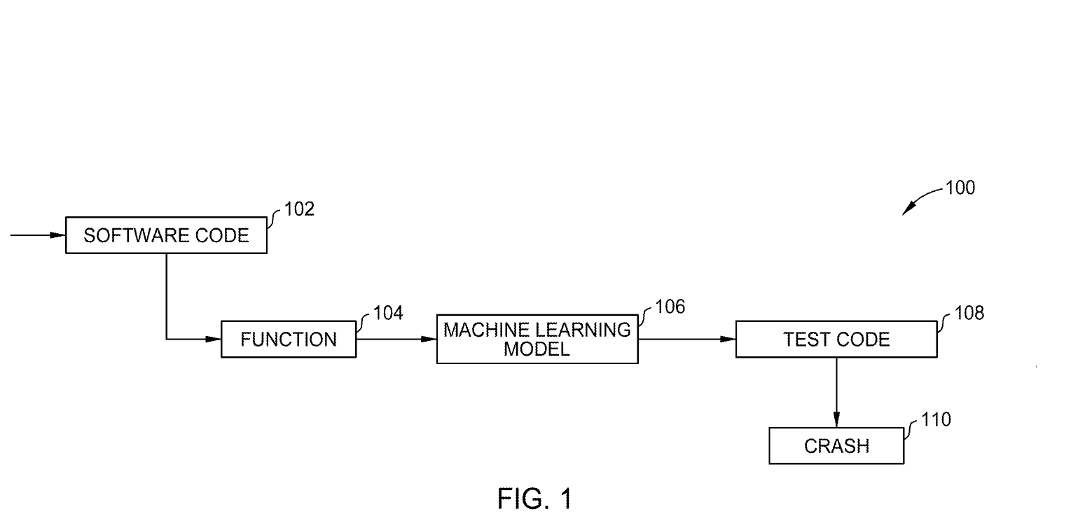

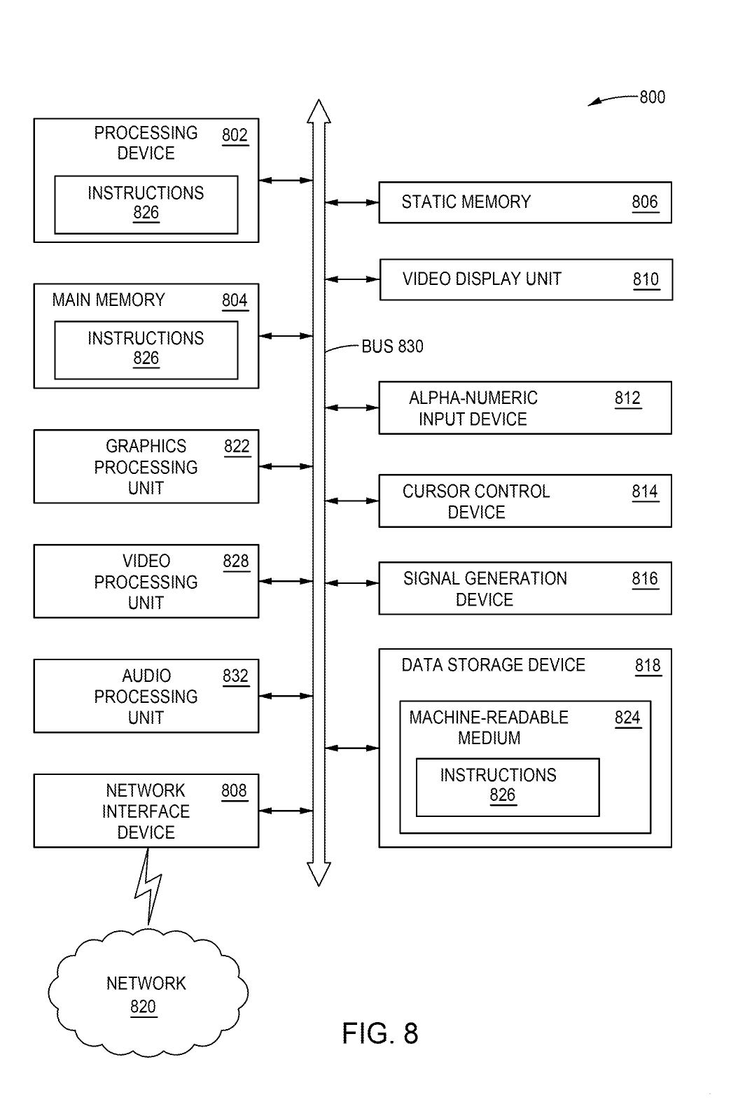

FIG. 1 illustrates an example operation 100 for testing software code performed by a computer system (e.g., the computer system 800 shown in FIG. 8). Generally, the computer system uses artificial intelligence to generate test code for testing functions in software code.

The computer system begins by receiving software code 102. For example, the computer system may retrieve the software code 102 from a database or repository. The software code 102 may be written in any software language and may include any number of functions that can be invoked, called, or executed to perform the functions. The computer system may parse the software code 102 to detect a function 104 in the software code 102. For example, the computer system may parse the software code 102 to detect syntax for the function 104. The syntax may reveal the name of the function 104 and the arguments or input that the function 104 expects when being invoked, called, or executed.

The computer system uses a machine learning model 106 to generate test code 108 that invokes, calls, or executes the function 104. For example, the computer system may generate a prompt using the function 104. The prompt may request that the machine learning model 106 generate the test code 108 that invokes, calls, or executes the function 104. The prompt may include additional information for the machine learning model 106. For example, the prompt may indicate a role that the machine learning model 106 should play when generating the test code 108. As another example, the prompt may include example test code. The machine learning model 106 may pattern or base the test code 108 off the structure, style, or syntax of the example test code. As another example, the prompt may specify the programming language that the machine learning model 106 should use to generate the test code 108. In this manner, the machine learning model 106 may be requested to produce the test code 108 using any programming language.

The machine learning model 106 may be any model that generates text to respond to input prompts. For example, the machine learning model 106 may be a large language model that generates textual responses to prompts. If the prompts request the machine learning model 106 to generate software code to invoke, call, or execute the function 104, then the machine learning model 106 responds to that prompt by generating the test code 108.

The computer system may execute the test code 108 to invoke, call, or execute the function 104. In some instances, the test code 108 may include bugs that prevent the test code 108 from invoking, calling, or executing the function 104. If such an error occurs, the computer system may direct the error to the machine learning model 106 so that the machine learning model 106 may adjust the test code 108 to resolve or fix the bugs. In this manner, the machine learning model 106 may be used iteratively to generate test code 108 that successfully invokes, calls, or executes the function 104.

The function 104 may include bugs that cause the function 104 to execute improperly or incorrectly. In some instances, invoking, calling, or executing the function 104 using the test code 108 generates a crash 110. When the crash 110 occurs, the computer system logs information about the crash 110. For example, the computer system may generate a stack trace, memory dump, etc. that allows the code for the function 104 to be analyzed to determine the cause of the crash 110. The code for the function 104 may then be adjusted to fix the bug and to resolve the crash. In this manner, the computer system generates test code to test software functions, which may allow bugs in software functions to be detected and fixed.

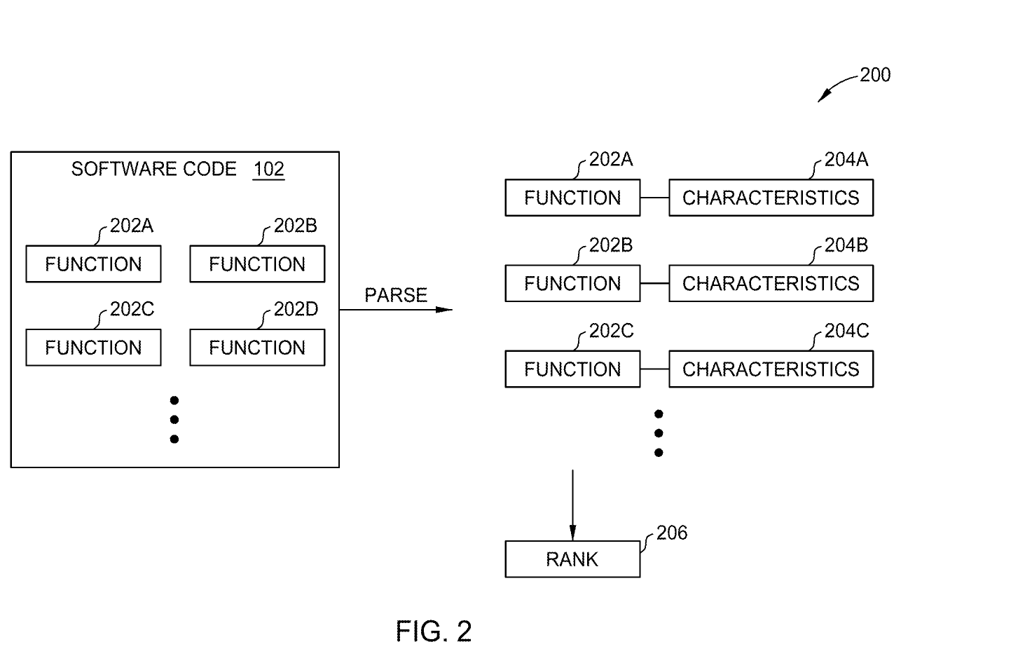

FIG. 2 illustrates an example operation 200 for parsing software code performed by a computer system (e.g., the computer system 800 shown in FIG. 8). The computer system begins by receiving or retrieving the software code 102. For example, the computer system may receive or retrieve the software code 102 from a database or repository. As seen in FIG. 2, the software code 102 includes multiple functions 202. In the example of FIG. 2, the software code 102 includes the functions 202A, 202B, 202C, and 202D. Each of the functions 202A, 202B, 202C, and 202D may have different definitions and/or different code.

The computer system parses the software code 102 to identify the functions 202A, 202B, 202C, and 202D. Parsing the software code 102 may involve analyzing the text of the software code 102 to identify syntax or structures indicating or defining the functions 202. When the computer system identifies such text, the computer system extracts the text as an identified function 202. The computer system may also analyze text following the identified text in the software code 102 to determine characteristics 204 of the identified functions 202. These characteristics 204 may describe aspects of calling, invoking, or executing the functions 202. For example, the characteristics 204 may include whether the functions 202 take arguments when being called, invoked, or executed, and if so, the number of arguments. As another example, the characteristics 204 may indicate whether the functions 202 are internal functions (e.g., whether a function 202 is called only from within another function 202). As another example, the characteristics 204 may include names of the functions 202 and/or the return type of the functions 202. In the example of FIG. 2, the computer system determines the characteristics 204A for the function 202A, the characteristics 204B for the function 202B, and the characteristics 204C for the function 202C.

In some instances, the software code 102 may include a large number of functions 202, and it may not be expedient or practical for the computer system to generate test code for every function 202. To reduce the load on the computer system, the computer system may rank the identified functions 202 based on the characteristics 204. The computer system may determine a rank 206 for each function 202, and the computer system may generate test code for a certain number of the highest ranked functions 202. The computer system may not generate test code for lower ranked functions 202.

The computer system may determine the rank 206 for a function 202 using any criteria. For example, the computer system may assign a higher rank 206 to the function 202 if the function 202 is not an internal function. As another example, the computer system may assign a lower rank 206 to the function 202 if the function 202 takes no arguments. As another example, the computer system may assign a higher rank 206 to the function 202 if the function 202 takes a large number of arguments or has specific words in the name of the function 202, both of which may indicate that the function 202 is more complex. The computer system may also rank the function 202 using other measurements of complexity, such as Halstead B and cyclomatic complexity, which may indicate the complexity of the body or implementation of the function 202.

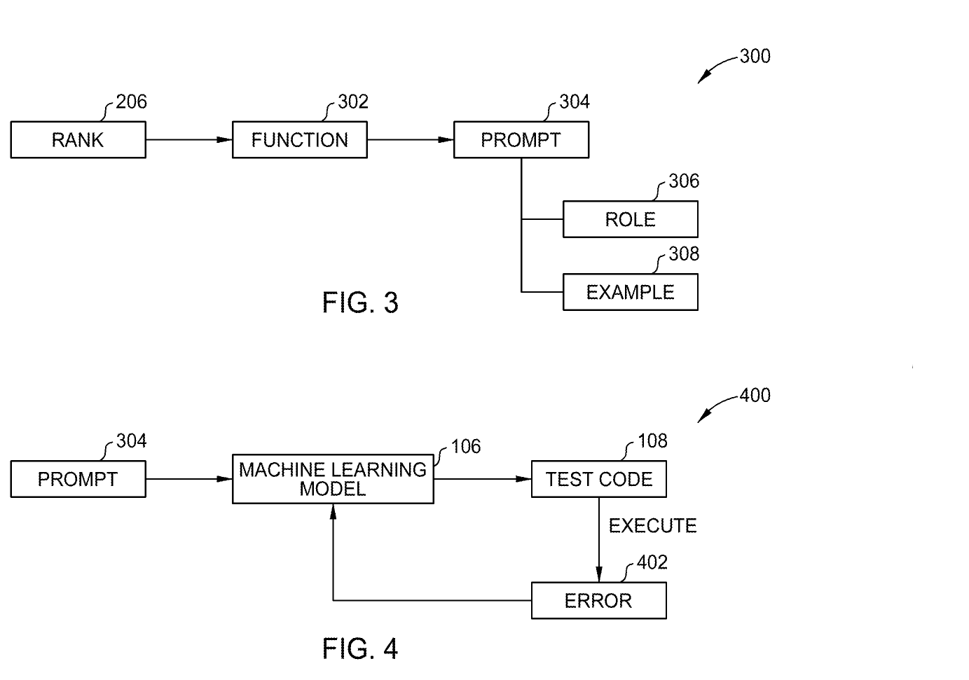

FIG. 3 illustrates an example operation 300 for generating a prompt performed by a computer system (e.g., the computer system 800 shown in FIG. 8). The computer system by selecting a function 302 based on the rank 206 for the function 302 (e.g., a high rank 206). The computer system then generates a prompt 304 using the function 302. The prompt 304 may request that test code be generated to test the function 302. For example, the prompt 304 may include an instruction such as “Please generate test code to invoke, call, or execute the following function” followed by the name or definition for the function 302.

The prompt 304 may include other information that guides the generation of the test code. For example, the prompt 304 may indicate a role 306 to be played when generating the test code. The role 306 may indicate a profession, personality, or other characteristic of a person to be impersonated or imitated when generating the test code. As an example, the role 306 may indicate that “the test code should be written as if it were written by a software engineer.”

The prompt 304 may also include one or more examples 308 of test code. These examples 308 may include example test code that tests other functions. The examples 308 may provide structures or syntax patterns to follow when generating the test code for the function 302. Additionally, the examples 308 may use the same programming language as the function 302.

FIG. 4 illustrates an example operation 400 for generating test code performed by a computer system (e.g., the computer system 800 shown in FIG. 8). The computer system begins by direct the prompt 304 to the machine learning model 106. The machine learning model 106 may be a large language model that responds to the prompt 304 by generating the test code 108. The test code 108 may include lines of code that set up arguments or the environment for invoking, calling, or executing a function. The test code 108 may then invoke, call, or execute the function.

In some embodiments, the test code 108 may include bugs that cause the test code 108 to throw an error 402 when the test code 108 is executed. For example, the test code 108 may include syntax errors or other errors that may cause the test code 108 to not invoke, call, or execute the function. For example, the error 402 may be a build-time error or a run-time error. The computer system sends the error 402 to the machine learning model 106 so that the machine learning model 106 may adjust the test code 108 to fix the bug or error 402. For example, the computer system may generate another prompt based on the test code 108 and the error 402 and send the prompt to the machine learning model 106. The machine learning model 106 may responds to the prompt by adjusting the test code 108 or by generating a different version of the test code 108. The computer system may then execute the adjusted test code 108 to determine whether the adjusted test code 108 throws errors or whether the adjusted test code 108 invokes, calls, or executes the function. In this manner, the computer system uses the machine learning model 106 to resolve bugs or errors in the test code 108.

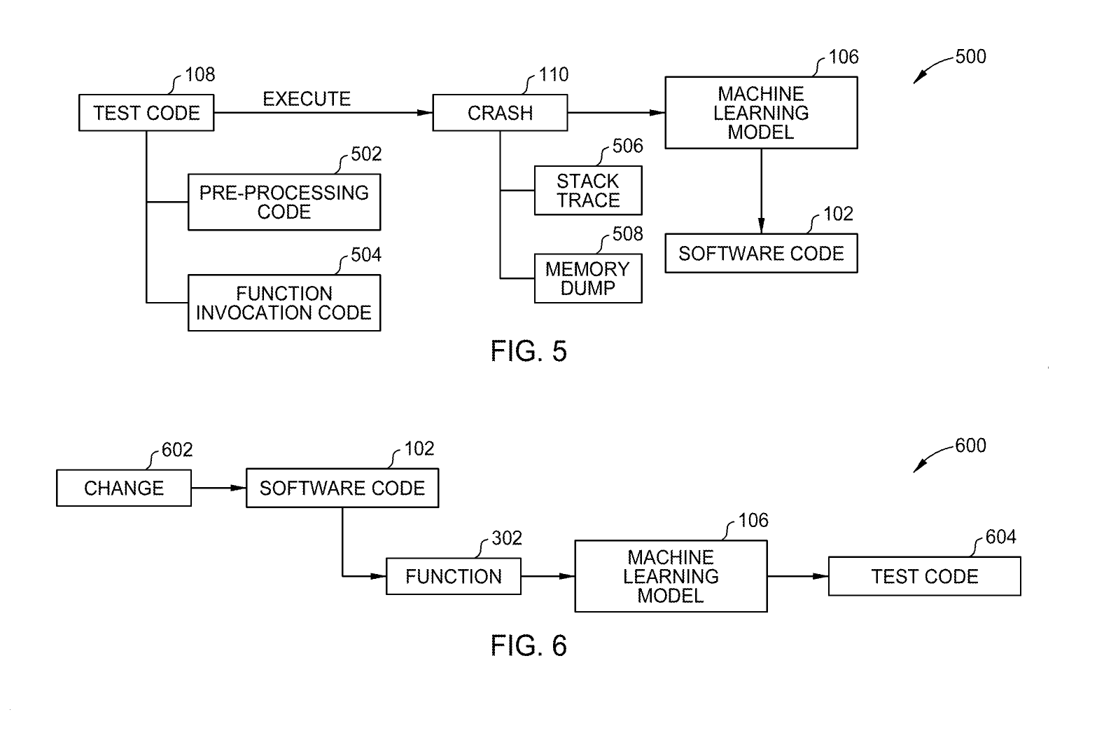

FIG. 5 illustrates an example operation 500 for executing test code performed by a computer system (e.g., the computer system 800 shown in FIG. 8). The computer system begins by executing the test code 108. As seen in FIG. 5, the test code 108 may include pre-processing code 502 and function invocation code 504. The pre-processing code 502 may include one or more lines of code that are executed prior to the function invocation code 504. The pre-processing code 502 may set up arguments and/or the environment for invoking, calling, or executing the function. The function invocation code 504 may include or more lines of code that invoke, call, or execute the function.

The computer system may execute the test code 108 with the goal of causing a crash. For example, the computer system may supply arguments to the function that include errors or that are unexpected by the function. As a result of these arguments, the function may cause a crash when the function is executed. In the example of FIG. 5, executing the test code 108 causes the crash 110 to occur.

The computer system may analyze the crash 110 to adjust the software code 102 to fix any issue in the software code 102 that caused the crash 110. For example, the computer system may analyze a stack trace 506 or a memory dump 508 for the crash 110 to determine a cause for the crash 110. The computer system then adjusts the software code 102 to resolve or fix the issue that caused the crash 110. For example, the computer system may adjust the function invocation code 504 to resolve or fix the issue.

In certain embodiments, the computer system uses the machine learning model 106 to adjust the software code 102 to resolve or fix the issue that caused the crash 110. For example, the computer system may direct the crash 110 along with the test code 108 to the machine learning model 106. The machine learning model 106 may analyze the crash 110 and the test code 108 to determine an adjustment to the software code 102 that would resolve or fix the issue that caused the crash 110. The computer system may then adjust the software code 102 accordingly.

In some instances, the computer system may determine, from the stack trace 506 and/or the memory dump 508, that the function invocation code 504 did not cause the crash 110. For example, the computer system may determine that the crash 110 occurred when executing the pre-processing code 502. In response, the computer system may adjust the pre-processing code 502 to resolve or fix the issue that caused the crash 110. If the pre-processing code 502 generated the crash 110, then the function invocation code 504 may not have been invoked or executed and the function may not have been tested. As a result, the computer system may discard the crash 110 and re-execute the test code 108 so that the function invocation code 504 can be executed and so that the function can be tested.

FIG. 6 illustrates an example operation 600 for adjusting test code performed by a computer system (e.g., the computer system 800 shown in FIG. 8). In some instances, the computer system stores the test code generated by the machine learning model 106 to test a function. The computer system may retrieve the test code for future tests of the function. When the computer system receive a change 602 to the software code 102, the computer system may determine that the change 602 is to a function 302 in the software code 102. The computer system may then determine that, with the change 602, the test code for the function 302 should also be changed.

The computer system directs the function 302 with the change 602 or the function 302 and/or the change 602 to the machine learning model 106. The machine learning model 106 may analyze the function 302 and/or the change 602 to determine how to adjust the test code for the function 302 to accommodate or incorporate the change 602. For example, if the change 602 adds an addition argument to the function 302, then the machine learning code may adjust the test code for the function 302 by adding the argument to the code that invokes the function 302. The machine learning model 106 produces the test code 604 (which may be the adjusted version of the test code for the function 302). The computer system may then use the test code 604 for subsequent testing of the function 302. In this manner, the computer system updates the test code for functions to accommodate changes to the functions.

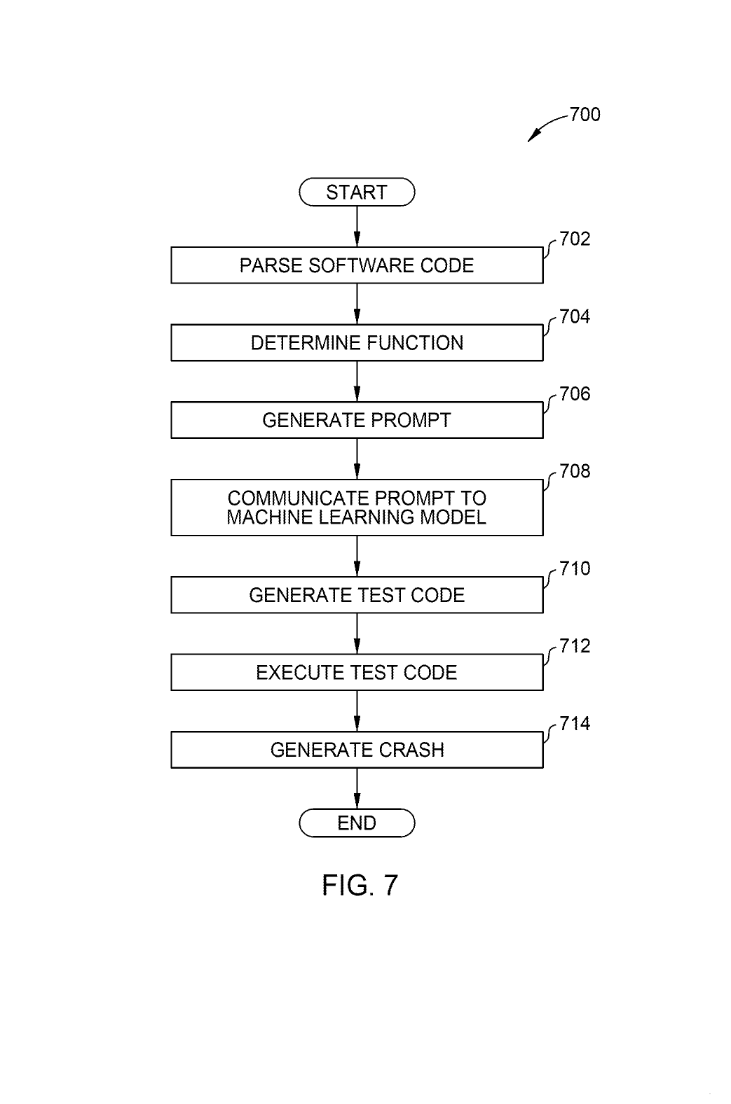

FIG. 7 is a flowchart of an example method 700 for testing software code performed by a computer system (e.g., the computer system 800 shown in FIG. 8). By performing the method 700, the computer system uses artificial intelligence to generate test code for testing a function in software code.

At 702, the computer system parses software code. The software code may include multiple functions that are called, invoked, or executed when the software code is executed. By parsing the software code, the computer identifies the text within the software code. At 704, the computer system analyzes the text to determine a function in the software code. For example, the computer system may analyze the text to locate syntax or code structures for the function. When the computer system locates the syntax or code structures, the computer system may determine that the function has been identified.

At 706, the computer system generates a prompt based on the function. For example, the prompt may include a request to generate test code that invokes, calls, or executes the function. The prompt may also include information that guides the generation of the test code. For example, the prompt may identify a role (e.g., software engineer) to be played when responding to the prompt. As another example, the prompt may include example test code that indicates the expected output of the test code generation process.

At 708, the computer system communicates the prompt to a machine learning model (e.g., a large language model). At 710, the machine learning model analyzes and responds to the prompt by generating the requested test code. The test code may include pre-processing code and function invocation code. The pre-processing code may set up arguments and the environment for the invocation, calling, or execution of the function. The function invocation code may invoke, call, or execute the function.

At 712, the computer system executes the test code, which may cause the function to be invoked, called, or executed. At 714, execution of the function generates a crash (e.g., due to a bug or error in the function). The computer system may analyze the crash (e.g., the stack trace and/or memory dump of the crash) to determine how to adjust the software code to resolve or fix the issue that caused the crash.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term "machine" shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term "machine-readable storage medium" should be taken to include a single medium or multiple media (e.g., a centralized or distributed database, and/or associated caches and servers) that store the one or more sets of instructions. The term "machine-readable storage medium" shall also be taken to include any medium that is capable of storing or encoding a set of instructions for execution by the machine and that cause the machine and the processing device 802 to perform any one or more of the methodologies of the present disclosure. The term "machine-readable storage medium" shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory ("ROM"), random access memory ("RAM"), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer system for generating test code, the computer system comprising:
one or more memories; and
one or more processors communicatively coupled to the one or more memories, the one or more processors configured to, individually or collectively:
parse software code to determine a function in the software code;
generate a prompt based on the function;
generate, using a machine learning model and based on the prompt, test code for testing the function; and
execute the test code to generate a crash.

2. The computer system of claim 1, wherein the one or more processors are further configured to, individually or collectively, prior to executing the test code to generate the crash:
execute the test code to generate an error;
communicate the error to the machine learning model; and
adjust, using the machine learning model, the test code to resolve the error.

3. The computer system of claim 1, wherein the one or more processors are further configured to, individually or collectively:
determine a plurality of functions in the software code based on parsing the software code;
rank the plurality of functions based on characteristics of the plurality of functions; and
select the function from the plurality of functions based on a rank of the function.

4. The computer system of claim 3, wherein the characteristics comprise at least one of:
a number of arguments;
whether a function is an internal function;
a name of a function; or
a complexity of a function.

5. The computer system of claim 1, wherein the prompt comprises at least one of:
a role to be played when generating the test code; or
an example of test code to be generated.

6. The computer system of claim 1, wherein the one or more processors are further configured to, individually or collectively:
communicate the crash to the machine learning model; and
adjust, using the machine learning model, the software code to resolve the crash.

7. The computer system of claim 1, wherein the one or more processors are further configured to, individually or collectively:
analyze a stack trace for the crash to determine that the function was not invoked when executing the test code; and
discard the crash based on determining that the function was not invoked when executing the test code.

8. The computer system of claim 1, wherein the one or more processors are further configured to, individually or collectively, adjust, using the machine learning model, the test code based on determining that the function changed.

9. A method for generating test code, the method comprising:
parsing software code to determine a function in the software code;
generating a prompt based on the function;
generating, using a machine learning model and based on the prompt, test code for testing the function; and
executing the test code to generate a crash.

10. The method of claim 9, further comprising, prior to executing the test code to generate the crash:
executing the test code to generate an error;
communicating the error to the machine learning model; and
adjusting, using the machine learning model, the test code to resolve the error.

11. The method of claim 9, further comprising:
determining a plurality of functions in the software code based on parsing the software code;
ranking the plurality of functions based on characteristics of the plurality of functions; and
selecting the function from the plurality of functions based on a rank of the function.

12. The method of claim 11, wherein the characteristics comprise at least one of:
a number of arguments;
whether a function is an internal function;
a name of a function; or
a complexity of a function.

13. The method of claim 9, wherein the prompt comprises at least one of:
a role to be played when generating the test code; or
an example of test code to be generated.

14. The method of claim 9, further comprising:
communicating the crash to the machine learning model; and
adjusting, using the machine learning model, the software code to resolve the crash.

15. The method of claim 9, further comprising:
analyzing a stack trace for the crash to determine that the function was not invoked when executing the test code; and
discarding the crash based on determining that the function was not invoked when executing the test code.

16. The method of claim 9, further comprising adjusting, using the machine learning model, the test code based on determining that the function changed.

17. A non-transitory computer readable medium storing instructions for generating test code that, when executed by one or more processors, cause the one or more processors to, individually or collectively:
parse software code to determine a function in the software code;
generate a prompt based on the function;
generate, using a machine learning model and based on the prompt, test code for testing the function;
execute the test code to generate an error;
adjust, using the machine learning model, the test code to resolve the error; and
execute the adjusted test code to generate a crash.

18. The medium of claim 17, wherein the instructions further cause the one or more processors to, individually or collectively:
determine a plurality of functions in the software code based on parsing the software code;
rank the plurality of functions based on characteristics of the plurality of functions; and
select the function from the plurality of functions based on a rank of the function.

19. The medium of claim 18, wherein the characteristics comprise at least one of:
a number of arguments;
whether a function is an internal function;
a name of a function; or
a complexity of a function.

20. The medium of claim 17, wherein the prompt comprises at least one of:
a role to be played when generating the test code; or
an example of test code to be generated.
